(19) United States
(12) Patent Application Publication
(10) Pub. No.: US 2003/0140158 A1
(43) Pub. Date: Jul. 24, 2003

(54) Multimedia data management system and method of managing multimedia data

(75) Inventors: Yong-Jai Lee, Seoul City (KR); Byung-Chul Choi, Seoul City (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD., Suwon-City (KR)

(21) Appl. No.: 10/234,236

(22) Filed: Sep. 5, 2002

(30) Foreign Application Priority Data
Jan. 21, 2002 (KR) 2002-3312

(51) Int. Cl. G06F 15/16

(52) U.S. Cl. 709/231

(57) ABSTRACT

A multimedia data management system in communication with multimedia devices via a network and allowing management of multimedia data of the multimedia devices in an integrated manner, the system having a device interface to be connected to the multimedia devices that provide multimedia data services through the network; a main storage storing respective multimedia data stored in the multimedia devices; a selector allowing a user to select reproduction of the multimedia data; and a controller storing the multimedia data supplied through the device interface from the multimedia devices in the main storage, producing a list of the multimedia data stored in the main storage and reporting the list to a user, reading the multimedia data stored in the main storage according to a reproduction selection of the multimedia data through the selector and supplying the selected multimedia data to the selected multimedia device through the device interface.

### CROSS-REFERENCE TO RELATED APPLICATIONS

This application claims the benefit of Korean Application No. 2002-3312 filed Jan. 21, 2002, in the Korean Intellectual Property Office, the disclosure of which is incorporated herein by reference.

### BACKGROUND OF THE INVENTION

1. Field of the Invention

The present invention relates in general to a system and a method of managing multimedia data, and more particularly, to a management system of multimedia data and a management method of the same, wherein multimedia data stored in a plurality of multimedia devices connected via network can be managed en bloc.

2. Description of the Related Art

Keeping with development of digital technologies, provision of multimedia services has been available on a grand scale. Multimedia represents a new system and service processing a variety of information in the form of text, voice, sound, graphics, pictures, images, etc., in an integrated manner, to thereby enable users to see, hear and feel variety of information through a variety of input/output devices. In accordance with this, a variety of devices supporting multimedia services, such as portable digital assistants (PDAs), web TVs, Web pads, digital cameras, Internet audios as well as computer systems, have shown up in the market. In a large number of cases, general users have installed a variety of multimedia devices at their homes.

However, among the multimedia devices, data exchange between analog devices and digital devices has not been available. Further, even when a variety of multimedia devices are installed in a computer system, to reproduce (e.g., view) any desired multimedia data stored in a multimedia device, a user must directly access each multimedia device storing therein the desired data. Further, even though the multimedia device is accessed via a network system, it is not possible to manage the multimedia data stored in the multimedia devices in an integrated manner because they are separately stored in their respective devices.

### SUMMARY OF THE INVENTION

Accordingly, it is an aspect of the present invention to provide a multimedia data management system and a management method in which multimedia data stored in a plurality of multimedia devices connected via network can be managed in an integrated manner.

Additional objects and advantages of the invention will be set forth in part in the description which follows and, in part, will be obvious from the description, or may be learned by practice of the invention.

The present invention may be attained by provision of a multimedia data management system in communication with multimedia devices via a network and the management system comprising a device interface to be connected to the multimedia devices that provide multimedia data services through the network; a main storage storing therein respective multimedia data stored in the multimedia devices; a selector unit allowing a user to select reproduction of the multimedia data at a multimedia device; a display unit displaying data; and a controller storing the multimedia data supplied through the device interface from the multimedia devices in the main storage, producing a list of the multimedia data stored in the main storage and reporting the list to a user by the display unit, reading the multimedia data stored in the main storage according to a reproduction selection of the multimedia data through the selector unit and supplying the selected multimedia data to the selected multimedia device through the device interface.

According to an aspect of the invention, the system further comprises a data processing unit converting the multimedia data stored in the main storage into data reproducible in respective multimedia devices, wherein the controller converts the selected multimedia data stored in the main storage into data reproducible in the selected multimedia device through the data processing unit and provides selected multimedia data to the selected multimedia device.

According to an aspect of the invention, the system further comprises an Internet interface accessing the Internet; wherein the controller stores the multimedia data supplied through the Internet interface in the main storage and produces a list of the stored multimedia data.

According to an aspect of the invention, the controller compares the multimedia data stored in the main storage with the multimedia data stored in the multimedia devices on the network and if new/updated multimedia data is found in the multimedia devices, stores the new/updated multimedia data in the main storage and updates the list of the multimedia data with information about the new/updated multimedia data.

According to another aspect of the present invention, the present invention can be attained by a method of managing multimedia data, comprising sensing a plurality of multimedia devices on a network; storing respective multimedia data stored in the plurality of sensed multimedia devices in a main storage en bloc; producing a list of the multimedia data stored in the main storage and reporting the list to a user; and providing the multimedia data stored in the main storage to a multimedia device based upon the user's multimedia data reproduction selection.

According to an aspect of the invention, providing the multimedia data to the multimedia device further comprises converting the selected multimedia data into data reproducible in the selected multimedia device.

According to an aspect of the invention, the method further comprises storing the multimedia data supplied from the Internet in the main storage.

According to an aspect of the invention, the method further comprises comparing the multimedia data stored in the main storage with the multimedia data stored in the plurality of multimedia devices on the network; if new/updated multimedia data is found in the multimedia devices as a result of the comparison, storing the new/updated multimedia data in the main storage; and updating the list of the multimedia data with information about the new/updated multimedia data.

### BRIEF DESCRIPTION OF THE DRAWINGS

The present invention will be better understood and its various objects and advantages will be more fully appreciated from the following description of the example embodiments taken in conjunction with the accompanying drawings, in which:

FIG. 1 is a control block diagram showing an embodiment controlling multimedia devices by use of a multimedia data management system according to an embodiment of the present invention;

FIG. 2 is a control block diagram of the multimedia data management system of FIG. 1;

FIG. 3 is a flow chart showing a multimedia data management method according to the present invention; and

FIG. 4 is a flow chart showing a multimedia data management method according to another embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below to explain the present invention by referring to the figures.

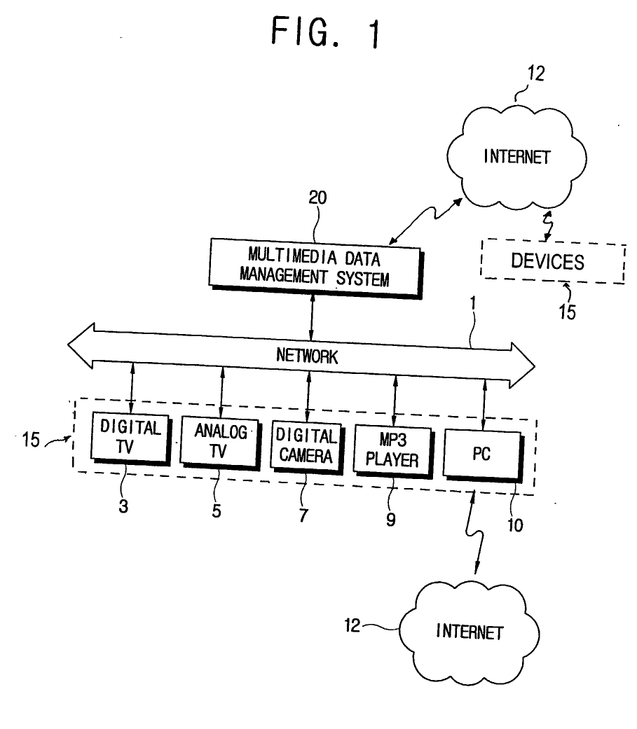

FIG. 1 is a control block diagram showing an embodiment controlling multimedia devices by use of a multimedia data management system according to the present invention. As illustrated therein, the multimedia data management system 20 and a variety of multimedia devices 15 are in communication via a network 1.

The multimedia devices 15 can comprise digital TVs 3 and digital cameras 7, that process digital image data, such as pictures, moving pictures, MP3 players 9 that process digital audio data, analog TVs 5 that reproduce analog image data, and PCs 10 that receive and process a variety of multimedia data supplied from Internet 12.

According to an aspect of the invention, the network 1 allows each multimedia device 15 to be connected directly to the multimedia data management system 20. The multimedia data management 20 employs a network interface supporting high-speed transmission of multimedia data. Example network interfaces can be wired interfaces, such as an IEEE1394 interface or a USB interface, Home PNA, etc., and wireless solutions, such as Bluetooth and so on.

The multimedia data management system 20 stores in an integrated manner within the system 20 a variety of multimedia data from a plurality of the multimedia devices 15 connected to the network 1. The multimedia data management system 20 produces a list of the multimedia data stored therein and provides the list to a user. Further, the multimedia data management system 20 updates in a continuous manner new/updated multimedia data stored in the multimedia devices 15 connected to the network 1, such as the separately positioned multimedia devices 3, 5, 7, 9, and 10.

Each multimedia data list can comprise data specification (format) information, updating date of the data and the multimedia devices corresponding to the data, etc.

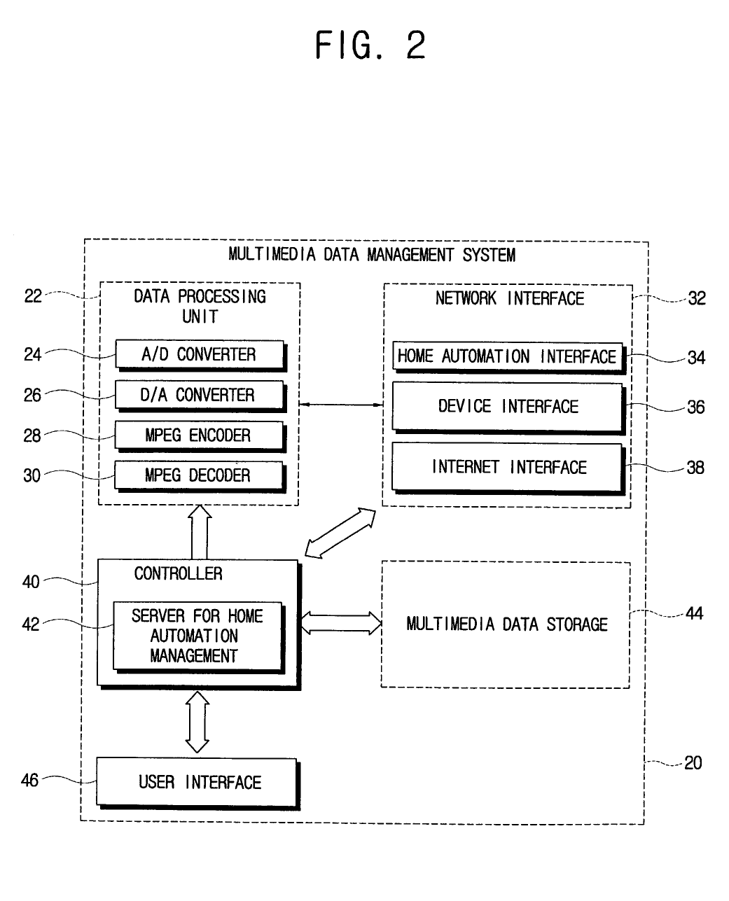

FIG. 2 is a control block diagram of the multimedia data management system 20 of FIG. 1. As shown in FIG. 1, the multimedia data management system 20 comprises a network interface 32 providing data reception and transmission via the network 1, a multimedia data storage 44, which is a main storage storing therein the variety of multimedia data received through the network interface 32, a data processor 22 processing the multimedia data, a user interface 36 providing an interface between a user and the multimedia data management system 20, and a controller 40 controlling the data processing unit 22, the network interface 32, the user interface 36 and the multimedia data storage 44.

The network interface 32 comprises a device interface 36 providing access to the multimedia devices, an Internet interface 38 providing access to the Internet and a home automation interface 34 providing access to home automated devices.

The device interface 36 is an interface directly accessing multimedia devices 15 on the network 1, recognizing the respective devices and receiving and transmitting multimedia data to/from the respective devices 15. Thus, multimedia devices 15 can be multimedia devices that provide multimedia data services by using an interface of IEEE1394 or USB protocol that allow easy connection to the devices 15, supporting fast transmission speed and enabling communication between each multimedia device 15.

The Internet interface 38 provides Internet connection, allowing the multimedia data provided through the Internet 12 to be directly received in the multimedia data management system 20. Thus, an Internet accessing device can be used as the Internet interface 38, such as LAN cards, cable modems, DSL (Digital Subscriber Line) cables and so on.

The home automation interface 34 provides access to a variety of electronic appliances having no multimedia functions.

The controller 40 senses connection to or disconnection from the network 1 by the multimedia devices 15 through the device interface 36 of the network interface 32. If determined that a multimedia device 15 is connected to the network 1, the controller 40 scans the multimedia data stored in a memory installed within the sensed multimedia device 15 and stores the multimedia data from the sensed multimedia device 15 in the multimedia data storage 44.

For example, if it is ascertained that a digital camera 7 is in communication with the network 1, the controller 40 scans the multimedia data stored in the digital camera 7 and stores camera's multimedia data in the multimedia data storage 44. Further, moving picture data in a status of being photographed and produced by the digital camera 7 can also be allowed to be stored immediately in the multimedia data storage 44 of the multimedia data management system 20, as controlled by the controller 40, thereby allowing real-time storage, in the data storage 44, of multimedia data supplied from the devices 15 in real-time. Further, as a multimedia data service provided by a multimedia device 15, where the inherent memory capacity of the multimedia devices 15 is small, it is possible to directly store the multimedia data of the devices in the multimedia data storage 44 without passing through the devices.

Further, the controller 40 produces a list of the multimedia data stored in the multimedia data storage 44. Further, the controller 40 can scan the multimedia data stored in the multimedia devices 15 in a continuous manner to update the multimedia data of the data storage 44 with any added/new data from the multimedia devices 15.

The updating can be performed periodically at predetermined time intervals when the user sets up. If the user sets up a specific time or a specific day, etc., for this purpose, the controller 40 can sense either status of connection to or disconnection of the multimedia device 15 with the network 1 according to the predetermined time, and can update the storage 44 with newly added/updated multimedia data based upon the multimedia data stored in the multimedia device 15. An updating time of a new multimedia data can be reported to the user, making it more easy to manage the user's data.

Also, the controller 40 allows the management system 20 to be connected to the Internet 12 through the Internet interface 38 and stores the multimedia data provided through the Internet 12 within the multimedia data management system 20 so as to manage the multimedia data. Therefore, it is made possible to also store multimedia data provided by VOD (video on demand) services or Internet audio services through the Internet 12 in the storage 44 of the multimedia data.

The home automated interface 34 allows functions of the multimedia data management system 20 to be associated with functions of home automation, to thereby allow the multimedia data management system 20 to also manage home electronic appliances as well as multimedia devices. In this case, the controller 40 is equipped with a management server 42 providing home automation management, thereby making it possible to control general electronic appliances through the home automation interface 34.

The data processing unit 22 comprises a variety of methods of converting the multimedia data stored in the multimedia data storage 44 to adaptively meet data reproduction specifications of respective multimedia devices 15. Accordingly, the data processing unit 22 can comprise an A/D converter 24, a D/A converter 26 and an MPEG encoder 28 and an MPEG decoder 30, etc., processing image data and audio data. The A/D converter 24 and the D/A converter 26 allow digital data and analog data to be convertible between them, and the MPEG encoder 28 and the MPEG decoder 30 process the multimedia data received and transmitted in a compressed state. In addition, the data processing unit 22 may further comprise a video encoder/decoder (not shown) to process video data of displaying apparatuses (e.g. monitors, TVs) and an audio CODEC to process audio data of the displaying apparatuses.

Accordingly, if a multimedia data format to be reproduced at a target multimedia device 15 does not meet a multimedia data format of the target multimedia device, the controller 40 can provide the multimedia data to be reproduced in a compatible format with the target multimedia device through the device interface 36 after converting the multimedia data to be reproduced through the data processing unit 22.

For example, if a user desires to reproduce multimedia data in an MPEG-2 form at the analog TV 5, the controller 40 decompresses the digital moving picture data stored in the multimedia data storage 44 through the MPEG decoder 30 and converts the decompressed multimedia data into digital picture signals, converts the digital picture signals into analog signals via the D/A converter 26, encodes the analog signals into video signals through the video encoder and provides the video signals to the analog TV 5, thereby being capable of ascertaining (i.e, displaying) contents of the MPEG-2 multimedia data in the analog TV 5.

Therefore, the controller 40 can convert the multimedia data stored in the storage 44 into a variety of formats supplied from a variety of multimedia devices through the data processing unit 22 and provides multimedia data in a format reproducible by any multimedia device connected to network 1 and desiring to be supplied with the multimedia data, thereby enabling data exchange between the multimedia devices 15. The user interface 46 accommodates function selection of the multimedia data management system 20 via input data, accommodates environment setting via input data, accommodates ascertaining (i.e., determining) a state of the multimedia data management system 20 via a display unit, or accommodates reporting the list of the multimedia data stored in the multimedia data storage 44. Thus, in an example embodiment, general input devices can be used, such as a remote controller, a key pad, a keyboard, a touch panel and so on, and the displaying unit can be a monitor or an LCD panel and so on.

Thus, the controller 40 reports the multimedia data list stored in the multimedia data management system 20 through a displaying apparatus of the user interface 46 and controls the multimedia data management system 20 responsive to a user's input commands through the input device of the user interface 46. Accordingly, the user can edit the multimedia data list through the user interface 46 or select any desired multimedia data to be reproduced in any desired multimedia device 15. Further, the user can ascertain (i.e., manage) the multimedia data in his/her possession en bloc through the multimedia data management system 20, on the one hand, and manage the multimedia data separately stored in respective multimedia devices 15 in an integrated manner.

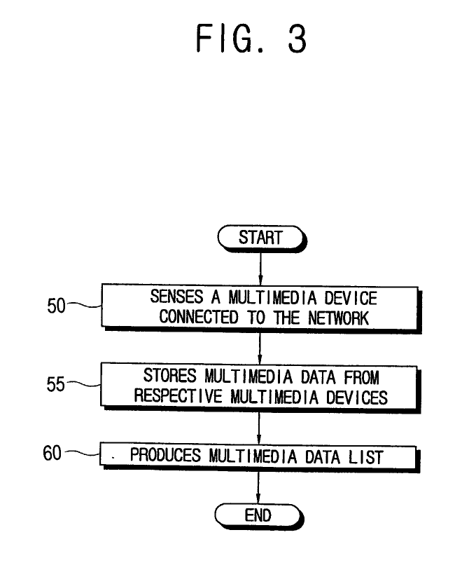

A method of controlling the multimedia data management system 20 is shown in FIG. 3. If the network 1 is structured between the multimedia data management system 20 and a variety of multimedia devices 15, at operation 50, the controller 40 of the multimedia data management system 20 first senses whether a multimedia device is connected to the network 1 through the device interface 36. The controller 40 stores a list of the multimedia devices 15 connected to the network 1 to thereby manage devices 15 in a continuous manner. At operation 55, the controller 40 is provided with the multimedia data supplied from each of the sensed multimedia devices 15 through the device interface 36 and stores the multimedia data in the multimedia data storage 44. At operation 60, the controller 40 produces a list of various multimedia data stored in the multimedia storage 44. The multimedia data list produced in such a way is provided to the user through the user interface 46, and therefore, the user can ascertain (i.e., manage) the user's multimedia data from the devices 15 in a prompt manner and select reproduction of any desired multimedia data.

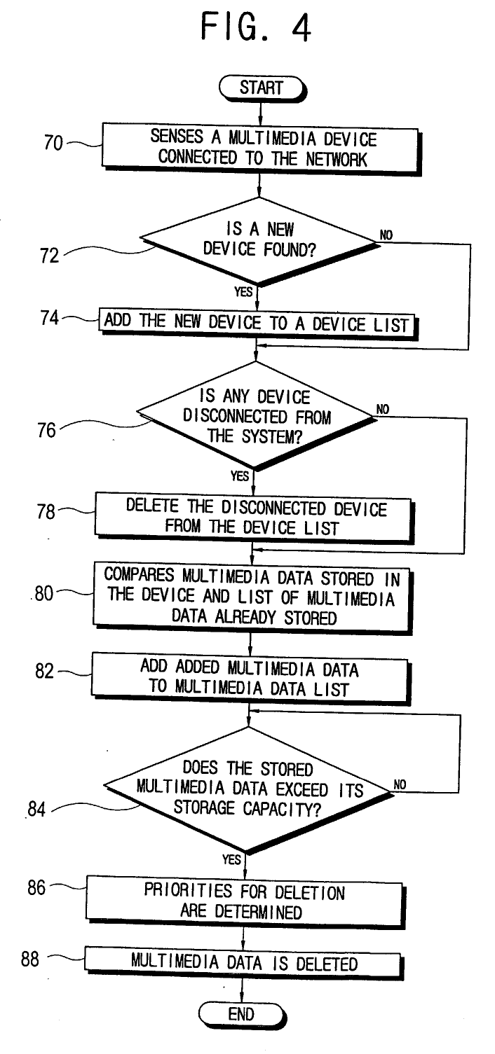

FIG. 4 is a flow chart showing a multimedia data management method according to another embodiment of the present invention. At operation 70, the controller 40 continuously senses connected multimedia devices 15 through the device interface 36. At operation 72, the controller 40 determines whether a new device among the sensed multimedia devices 15 is connected, and adds a new sensed device to the device list in a case that a new device is connected to the network 1. Also, at operation 76, the controller 40 senses whether there is any device which is disconnected from the network 1 and, if any, at operation 78, deletes the disconnected device from the device list. The multimedia data stored in the disconnected device is retained in the multimedia data storage 44 of the multimedia data management system 20 so that the user can reproduce the multimedia data of the disconnected device through other devices 15 even though the device corresponding to the retained multimedia data is disconnected.

When devices 15 checking operations 70-78 are completed, at operation 80, the controller 40 compares the multimedia data stored in the respective devices 15 with the multimedia data list previously produced. At operation 82, if any added multimedia data is stored in the multimedia data storage 44, the multimedia data list is accordingly updated. During the data checking operations 80 through 82, data can be retained in the multimedia data storage 44 for a predetermined period of time even if the data has already been deleted from the corresponding device 15.

At operation 84, while the new multimedia data is being stored, the controller 40 checks whether the multimedia data storage 44 has exceeded its storage capacity. In the case that the storage capacity of the data storage 44 is exceeded, at operation 86 deletion priorities of the data stored in the multimedia data storage 44 are determined according to predetermined criteria and at operation 88 the data are deleted in sequence. The deletion priorities of data can be determined in advance by the user through the user interface 46. Where there are no predetermined standards for deletion, the controller 40 can determine deletion priorities based on other pre-configurations, such as time of updating the multimedia data, reproduction number of data and time of the last reproduction, etc., and the controller 40 deletes data in sequence accordingly, to thereby secure a data storage space. Thus, the deletion function can be performed within the multimedia data management system 20.

Therefore, the present invention allows multimedia data stored in respective multimedia devices 15 connected to the network 1 to be stored in a main storage 44 in an integrated manner and provides the user with a list of the stored multimedia data. In particular, the user may access (e.g., reproduce to view) desired multimedia data from any of the multimedia devices 15 without directly accessing the multimedia device 15. On the other hand, any multimedia data added to the multimedia devices 15 can be automatically sensed, to thereby allow data to be updated in a continuous manner. Also, the present invention allows the stored multimedia data to be converted into any format as desired by a multimedia device 15 based upon the user's data reproduction selection and provides the selected multimedia data as converted to the selected multimedia devices 15. Accordingly, the user can manage a variety of multimedia data dispersed in a variety of the multimedia devices 15 systematically, and thereby, data can be exchanged between the multimedia devices 15. In particular, multimedia data can be exchanged among the multimedia devices 15, including data exchange among analog and digital multimedia devices 15.

As described above, according to the present invention there are provided a multimedia data management system and a management method of the same, in which the multimedia data stored in a plurality of multimedia devices connected to a network can be managed in an integrated manner.

Although the preferred embodiments of the present invention have been disclosed for illustrative purposes, those skilled in the art will appreciate that various modifications, additions and substitutions are possible, without departing from the scope and spirit of the invention the scope of which defined in the claims and their equivalents.

What is claimed is:

1. A multimedia data management system in communication with multimedia devices via a network, the system comprising:
a device interface interfacing with the multimedia devices that provide multimedia data services through the network;
a main storage storing respective multimedia data stored in the multimedia devices;
a selector allowing a user to select reproduction of the multimedia data stored in the main storage;
a displaying unit displaying data; and
a controller storing the multimedia data supplied through the device interface from the multimedia devices in the main storage, producing a list of the multimedia data stored in the main storage and reporting the list to the user by the displaying unit, reading the multimedia data stored in the main storage according to reproduction selection of the multimedia data through the selector and supplying the selected multimedia data to the selected multimedia device through the device interface.

2. The system according to claim 1, further comprising a data processing unit converting the multimedia data into data reproducible in the respective multimedia devices,
wherein the controller converts the selected multimedia data stored in the main storage into data reproducible in the selected multimedia device through the data processing unit and provides the selected multimedia data to the selected multimedia device.

3. The system according to claim 1, further comprising an Internet interface accessing the Internet;
wherein the controller stores the multimedia data supplied through the Internet interface in the main storage and produces a list of the stored multimedia data.

4. The system according to claim 1, wherein the controller compares the multimedia data stored in the main storage with the multimedia data stored in the multimedia devices on the network and stores any new multimedia data in the main storage if the new multimedia data is found in the multimedia devices and updates the list of the new multimedia data.

5. A method of managing multimedia data, comprising:
sensing multimedia devices on a network;
storing respective multimedia data stored in the sensed multimedia devices in a main storage en bloc;
producing a list of the multimedia data stored in the main storage and reporting the list to a user; and
providing the multimedia data stored in the main storage to one of the multimedia devices based upon a user's multimedia-data-reproduction selection.

6. The method according to claim 5, wherein the multimedia data is provided to the selected multimedia device by converting the selected multimedia data into data reproducible in the selected multimedia device.

7. The method according to claim 5, further comprising storing the multimedia data supplied from the Internet in the main storage.

8. The method according to claim 5, further comprising:
comparing the multimedia data stored in the main storage with the multimedia data stored in the multimedia devices on the network;
storing any new multimedia data in the main storage if the new multimedia data is found in one of the multimedia devices as a result of comparison; and
updating the list with the new multimedia data to be added to the main storage.

9. A system, comprising:
a network;
multimedia devices in communication with the network and providing multimedia data services; and
a multimedia management system in communication with the network and comprising a programmed processor storing the multimedia data from the multimedia devices via the network and managing reproduction of the stored multimedia data at any of the multimedia devices via the network.

10. The system of claim 9, wherein the multimedia management system automatically detects the multimedia devices in communication with the network and automatically stores multimedia data stored in and/or supplied from the multimedia devices that are in communication with the network.

11. The system of claim 9, wherein the multimedia management system further provides a listing of the stored multimedia data, retrieves the stored multimedia data responsive to a reproduction selection of the stored multimedia data at selected ones of the multimedia devices based upon the listing, and transmits the selected multimedia data to the selected multimedia devices.

12. The system of claim 11, wherein the multimedia management system further converts the selected multimedia data to data compatible with the selected multimedia devices.

13. The system of claim 9, wherein electronic appliances are in communication with the network and the multimedia management system further interfaces with the electronic appliances using the stored multimedia data.

14. The system of claim 9, wherein the multimedia management system further automatically detects the multimedia devices in communication with the network and automatically updates stored multimedia data corresponding to the multimedia devices that are in communication with the network with added and/or new multimedia data stored in and/or supplied from the communicating multimedia devices.

15. The system of claim 14, wherein the stored multimedia data are updated at configurable time intervals.

16. The system of claim 12, wherein the multimedia management system converts multimedia digital data to/from analog data and/or encodes/decodes multimedia data to be compatible with the selected multimedia devices.

17. The system of claim 9, wherein the multimedia management system further manages storage capacity by deleting the stored multimedia data according to a configurable deletion priority.

18. The system of claim 11, wherein the listing comprises multimedia data format information, update information and corresponding multimedia devices of the stored multimedia data.

19. The system of claim 9, wherein the multimedia management system further interfaces with Internet via the network and stores multimedia data from the Internet.

20. A multimedia management system in communication with multimedia devices via a network, the system comprising:
a programmed processor storing, en bloc, multimedia data stored in and/or supplied from the multimedia devices via the network and managing exchange of the multimedia data stored in and/or supplied from the multimedia devices among the multimedia devices based upon the en bloc stored multimedia data.

21. A multimedia management system, comprising:
a programmed processor in communication with a network and storing multimedia data of multimedia devices that provide multimedia data services via the network, receiving selection information of the stored multimedia data from a user via the network and transmitting the selected stored multimedia data to the selected multimedia devices responsive to the selection information via the network.

22. The multimedia management system of claim 21, wherein the network is Internet.
